(19) United States
(12) Patent Application Publication
(10) Pub. No.: US 2005/0217757 A1
(43) Pub. Date: Oct. 6, 2005

(54) Preflux, flux, solder paste and method of manufacturing lead-free soldered body

(76) Inventor: Yoshihiro Miyano, Sayama-shi (JP)

Correspondence Address: KING & SCHICKLI, PLLC, 247 NORTH BROADWAY, LEXINGTON, KY, 40507, US

(21) Appl. No.: 11/091,984

(22) Filed: Mar. 29, 2005

(30) Foreign Application Priority Data
Mar. 30, 2004 (JP) 2004-098166

(51) Int. Cl. B23K 35/34

(52) U.S. Cl. 148/24

(57) ABSTRACT

There is closed a flux which is designed to be used in a soldering using a lead-free and zinc-free solder containing tin as a major component and not containing lead, the soldering being adapted to be applied to a surface portion which is constituted by a copper-based metal and/or a nickel-based metal (excluding the case where the surface portion is constituted by electroless nickel plating), wherein the flux contains at least one kind of material selected from the group consisting of a copper-based metal, a nickel-based metal, an inorganic salt of copper-based metal and/or a nickel-based metal, an inorganic complex of copper-based metal and/or a nickel-based metal, and an organic complex of copper-based metal and/or a nickel-based metal (a metal complex of an organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal). There is also closed a method of manufacturing a lead-free soldered body wherein this flux is employed.

This application claims priority to Japanese Patent Application No. 2004-098166 filed on Mar. 30, 2004.

### TECHNICAL FIELD

This invention relates to a preflux, a flux and a solder paste, which are designed to be employed in soldering using a solder containing no lead, i.e. so-called lead-free solder and are capable of improving the wettability and bonding strength of lead-free solder to the copper foil land of printed wiring board for example. This invention also relates to a method of manufacturing a lead-free soldered body.

### BACKGROUND ART OF THE INVENTION

In the latest electric or electronic equipments, in the latest electric or electronic parts, or in the latest radiator of automobile, an Sn/Pb-based solder is employed for performing the bonding thereof. As for the method of bonding, there are known various methods including a troweling method using so-called resin-containing solder formed of a hollow solder wire having a hollow axis filled with a flux, a dip soldering method wherein a printed wiring board having electronic parts tack-welded is coated at first with a flux and then dipped in a fused solder, a jet soldering method wherein a printed wiring board having electronic parts tack-welded is coated at first with a flux and then dipped in a spouting fused solder, and a reflow soldering method wherein a solder paste comprising a mixture of solder powder and a flux is coated at first by making use of a screen, a metal mask or a dispenser and then the coated solder is permitted to reflow.

As for the flux to be employed in these soldering methods, there has been employed a flux comprising a rosin-based resin as a major component because of the reason that, since a residue of the flux after soldering is excellent in non-corrosion and insulating properties to a metal surface on which the solder is applied, the residue of the flux can be left behind without necessitating the removal thereof when the flux is employed in the soldering of electronic parts onto ordinary electronic equipments. Namely, in this flux, a rosin-based resin is employed as a base material to which an organic acid or amine halogenate is added as an activating agent, the resultant flux being subsequently dissolved in an alcoholic solvent if desired. In the case of a high-density package printed wiring board where the electronic equipments to be mounted thereon are required to be highly reliable or in the case where the environment in which electronic parts are used is required to be taken into account, the residue of flux is washed out and removed as required. Further, for use in the preliminary soldering of the leads of electronic parts or for use in the soldering coat for the wiring circuit of printed wiring board, a water soluble flux for the preliminary soldering of electronic parts where residual flux is water-soluble and can be washed out and removed with water, or a flux for soldering using a hot air leveler can be employed. These fluxes contain, as a base material, a water-soluble higher alcohol-based resin to which an organic activating agent is added, the resultant flux being subsequently dissolved in water or in an alcoholic solvent if desired. Further, for the purpose of soldering a metal which is hardly solderable or for the purpose of soldering a radiator, an inorganic flux comprising, as a base material, zinc chloride, ammonium chloride or hydrochloric acid, each having a strong activating power, is employed.

By the way, there is a problem in recent years that when electronic equipments are disintegrated and resultant components thus disintegrated are buried into underground on the occasion of abolishing the electronic equipments that has been fabricated through soldering using an Sn—Pb-based solder, the lead (Pb) in the solder is permitted to dissolve in water especially in ground water originating from acid rain if the disintegrated components is accompanied with the Sn—Pb-based solder, thus resulting in the contamination of natural environments or in so-called environmental contamination. Therefore, it is now studied all over the world to stipulate the regulations on the disposal of electronic equipments. Namely, it is now studied as a countermeasure for this problem to employ lead-free solders, such as Sn—Ag—Bi, Sn—Bi, Sn—Ag—Bi—Cu, Sn—Ag—Cu—In, Sn—Ag, Sn—Ag—Cu, Sn—Cu—Ni, Sn—Sb, Sn—In, Sn—Zn, etc. As a matter of fact, in some countries, the lead-free solders are employed.

However, these lead-free solders are accompanied with a problem that they are incapable of realizing the same degree of productivity and reliability in the soldering as obtainable in the employment of the conventional Sn—Pb-based solders. For example, as far as the productivity in the soldering is concerned, the dip soldering method and the jet soldering method, where an automatic soldering apparatus is employed, are accompanied with the problems including the generation of a soldering loss, the occurrence of defective wet of solder at the soldered portion, the generation of sagging of solder at the soldered portion, and the deterioration of yield due to the generation of defective such as the generation of bridge-like soldering to be formed between the neighboring electronic components. The soldering using a hot air leveler is accompanied with the problem that the wetting of solder to the copper foil land of a printed circuit board is poor. The reflow soldering using a solder paste is also accompanied with the problem that, partly due to the deterioration of printing property because of high tendency to fluctuate the viscosity of the solder paste, a solder ball is caused to generate, defective wetting is caused to generate, and the peeling of solder from the copper foil land is liable to occur.

Further, the lead-free solders are generally higher in melting point as compared with Sn—Pb eutectic solder, so that the soldering temperature thereof is required to be set higher. However, since the electronic parts such semiconductors are relatively poor in heat resistance, it is difficult to raise the soldering temperature. Bi-containing, Zn-containing or In-containing lead-free solders are also known as a low melting-point solder. However, these lead-free solders are also accompanied with the same kinds of problems as the lead-free solder of relatively low melting point has as described below. Moreover, these lead-free solders are accompanied with the problems that the solder alloy layer (intermetallic compound) is caused to excessively grow during or subsequent to the soldering to deteriorate the solder-bonding strength and that defective wetting of solder is caused to generate if the portion to be soldered is already applied with plating and if the material constituting the plating is incompatible with the solder. Other than the aforementioned problems, these lead-free solders are also accompanied with a number of problems. Any way, these problems can be classified roughly into the following two causes.

One of them is a problem of wettability of solder to the copper foil land of a printed wiring board, and the other is a problem originating from the kinds of solder alloy.

The causes for the former problem reside in the spreading of solder and in the wetting speed of solder. For example, when the solder-spreading test was performed according to JIS-Z-3197 by making use of a rosin-based post flux for printed wiring board which is commonly employed at present, while the degree of spreading of Sn—Pb-based solder was 93%, the degree of spreading of a lead-free solder (for example, a solder comprising 3.0 of Ag, 0.5 of Cu and the balance of Sn (JP Patent No. 3027441); a solder comprising 3.0 of Ag, 0.5 of Cu and the balance of Sn; a solder comprising 57 of Bi and the balance of Sn; a solder comprising 3.4 of Ag, 1.0 of Cu, 3.0 of Bi and the balance of Sn; other lead-free solders mentioned above) was only 80% or so, thus indicating considerable deterioration of wettability of solder.

In order to overcome the aforementioned problems, many attempts have been made to modify the conditions for soldering, including a method of raising the pre-heat temperature, a method of raising the soldering temperature, a method of performing the soldering in a nitrogen gas atmosphere, and a method of using a flux containing an activating agent which is high in activity. However, all of these attempts were found in effective in solving these problems. Further, even if lead-free solders such as an Sn—Zn solder and an Sn—Ag solder, both enabling to lower the melting point of solder, are employed, it has been impossible to secure a sufficient degree of wettability.

There is also known a method wherein a Sn plating, an Sn—Ag plating, an Sn—Bi plating, an Sn—Pb plating, a Au plating or a Ag plating is applied to a component lead wire, and then the lead wire is introduced into through-hole, etc. of a printed wiring board and then fixed thereto using a lead-free solder. In this case, although it may be possible to enhance the wettability of solder to the lead wire, the manufacturing cost would be increased, making the method impractical. Additionally, if dipping or jet soldering is to be performed, these plating metals are permitted to fuse into the fused solder placed in a solder tank, thus increasing the content of impurities in the solder.

With respect to the latter problem related to the kinds of solder alloy, many attempts have been made to modify the lead-free solder alloy so as to secure the same degree of workability, wettability of solder and bonding reliability of solder as those of the Sn—Pb solder. For example, various kinds of metals are added to a Sn-based solder, thus substituting various kinds of metals for the Pb of the Sn—Pb solder, thereby lowering the melting temperature of solder or enhancing the strength of solder itself. However, many of these metals to be added are stipulated as an impurity according to JIS Standard, so that these metals may obstruct the wettability of solder on the occasion of soldering, or the intermetallic compound created between these metals and the copper employed as a parent metal of the copper foil land of printed wiring board may be excessively produced as the printed wiring board is left in high temperatures after soldering, thereby making the bonded portion fragile and deteriorating the bonding strength or causing the generation of peeling of solder from the bonded portion in the worst case. If these problems are to be overcome, it is necessary to suppress the excessive growth of the intermetallic compound between the Sn of the solder and Zn or Cu. With a view to realize this, many studies have been conducted to find a suitable composition of solder which is effective for overcoming the aforementioned problems. However, no one has succeeded as yet to find such a composition of solder.

By the way, in addition to the aforementioned two problems, there are other problems on the substrate provided with a through-hole, said other problems including the peeling of solder from the soldering land, i.e. a phenomenon of lift-off, and a phenomenon of cracking of solidified solder which may be generated on the occasion of solidification thereof.

Even in the conventional flux, there are several examples where metal compounds are employed. However, they are all directed to a lead-containing solder such as an Sn—Pb-based solder and the objects of employing the metal compounds therein are not the same. For example, in the case of the flux for delustering soldering described in JP Patent No. 55-46798 (1980), it is designed to form organic stannate as a semispherical seed on the surface of soldered portion to reflect light, thereby enabling the solder to exhibit delustering effects. Likewise, in the case of the delustering flux described in JP Patent No. 51-18245 (1976), a metal compound is employed as a component insoluble to a rosin type resin for delustering the surface of solder or the surface of resist. Further, in the case of JP Laid-Open Patent Publication No. 9-1382 (1997) where a solder paste formed of soldering alloy powder containing zinc is described, it is proposed to coat the surface of solder particle with an imidazole-based or triazole-based rust-preventing agent or with gold, silver or tin (copper and nickel are not included), thereby preventing the soldering alloy powder from reacting with an activating agent in the flux, thus preventing the solderability and storage stability from being deteriorated. Namely, it is suggested in this Patent Publication that even if a lead-free solder is employed as a soldering powder, it is possible to expect excellent solder-spreading rate and excellent viscosity stability. Further, in the case of the flux for bonding metals described in JP Patent Publication No. 53-41627 (1978), pine resin, amine, a fluoride, borofluoride and metal fluoride (copper fluoride) are mixed together to obtain a mixture to which hydrofluoric acid or hydroborofluoric acid is added to separate a precipitate from the mother liquor, thus obtaining the flux for bonding metals. This flux is mainly employed for the soldering of aluminum and can be employed in the soldering using an Sn—Zn—Cd solder, an Sn—Pb—Cd solder, or a Cd—Zn solder. In the preparation of this flux, zinc chloride (known as an inorganic flux to be employed in the soldering of cast iron, aluminum, stainless steel, nickel alloy, all of which are conventionally considered difficult to solder), stannous chloride, hydrofluoric acid, hydroborofluoric acid or metallic salts thereof, and amine are combined with rosin to form the flux. In this case however, a precipitate to be obtained through the reaction thereof with hydrofluoric acid or hydroborofluoric acid is utilized, thus making the method troublesome.

Anyway, according these conventional solders, it is not suggested to add copper-based metals or nickel-based metals or metallic compounds of these metals to a flux for the purpose of enhancing the wettability of solder. In particular, the employment of these metals or metallic compounds is not intended to enhance the wettability of solder in the soldering using a lead-free solder.

As described above, a lead-free solder is poor in wet-spreading rate and hence in wettability to a matrix metal, in particular to a copper foil land. A lead-free solder where Pb in an Sn—Pb solder is replaced by other kinds of metals to thereby decrease the melting point of the solder is also accompanied with problems that the wettability thereof is poor, and that an intermetallic compound is permitted to excessively generate between the solder and the matrix metal, thus deteriorating the bonding strength of the solder. These problems cannot be overcome even if the soldering conditions, such as soldering temperature, etc., are altered.

With a view to solve these problems, there have been proposed to enhance the activity of the activating agent of flux by increase the content of the activating agent or, in addition to that, to alter the composition of various kinds of solder. For example, in the case of the lead-free solder where Cu is added to an Sn—Ag-based solder, it may be possible to enhance the wettability thereof, but the wettability thereof is still poor which is incomparable to that of the Sn—Pb-based solder. Even if this lead-free solder is employed together with a powerful flux where an inorganic acid or an inorganic salt is employed such as a zinc chloride-ammonium chloride-based flux which is usually employed in the soldering to be effected to an oxidized surface of matrix metal such as copper, iron, aluminum and nickel, it is still impossible to substantially improve the wettability of solder to the matrix metal, i.e. the wettability of the lead-free solder is far inferior as compared with that of the Sn—Pb-based solder.

By the way, followings are publications which are relevant to the present invention.

(i) JP Laid-Open Patent Publication No. 11-58065 (1999) describes a solder paste comprising a mixture of lead-free soldering alloy powder containing zinc and a flux, to which an organic or inorganic ester of a metal which is smaller in ionization tendency than zinc is added. It is alleged that, where this solder paste is employed in the soldering, it is possible to prevent the deterioration with time of the bonding strength between the solder and a copper substrate even if the product soldered is left standing under high-temperature conditions.

(ii) JP Laid-Open Patent Publication No. 2003-236695 describes the soldering using a lead-free solder wherein a flux for soldering to an electroless nickel substrate is incorporated with a metal salt which is smaller in ionization tendency than nickel and employed for the soldering. It is alleged that, when this solder is employed in the soldering, it is possible to prevent nickel from diffusing into the solder and to prevent the increase in concentration of phosphor, thus making it possible to enhance the bonding strength of solder.

(iii) JP Laid-Open Patent Publication No. 11-254184 describes a flux comprising a resin component as a major component to which an activating agent is added. To this flux is further added 0.5-50 wt % of an organic acid, especially a metal salt of monobasic acid to obtain a flux for lead-free solder. It is alleged that a lead-free solder paste employing this flux is excellent in wettability to a copper plate and in bonding strength. It is alleged that specially when a metal salt of monobasic acid such as bismuth naphthenate or lead rosinate is employed, the wettability and bonding strength can be extremely enhanced, that when copper rosinate is employed, these properties can be also enhanced though not better than those mentioned above, and that when bismuth acetate or bismuth maleate is employed, it is possible to enhance these properties higher than those where bismuth chloride is employed or where neither an organic acid nor a metal salt is employed though the enhancement of these properties may not be so excellent as described above.

(iv) JP Laid-Open Patent Publication No. 2003-251494 describes a lead-free precipitation type solder composition comprising tin and silver or comprising tin and copper and being capable of suppressing the release precipitation of silver and/or copper and also capable of preventing the reductive precipitation of silver or copper, thereby making it possible to form a suitable lead-free solder on the conductive surface of a circuit pattern, wherein this solder composition is constituted by metallic tin powder, and a complex consisting of silver ion and/or copper ion and aryl- or alkyl-phosphine or azole.

(v) JP Laid-Open Patent Publication No. 2004-42050 describes a flux to be employed on the occasion of performing soldering on a wiring circuit having electroless nickel plating formed thereon or on a gold plating formed on the electroless nickel plating, wherein the flux is constituted by a complex consisting of silver ion and/or copper ion, and phosphine, a nitrogen-containing heterocyclic compound or a compound having thiol, thioether or disulfide bond. It is alleged that when this flux is employed, the precipitation of silver or copper is caused to generate on a wiring pattern if the soldering temperature is not lower than 150° C. but the precipitation of silver or copper is not caused to generate on the regions other than the wiring pattern if the soldering temperature is not higher than 280° C.

The fluxes proposed in the above items (ii) and (v) are all directed to the case where the portion to be soldered is formed of electroless nickel plating. In the solder paste proposed in the above item (i), there is employed a lead-free solder powder containing zinc which is highly reactive to the activating agent in the flux. In the above item (iii), a metal solt of organic acid is used. The materials proposed in the above items (iv) and (v) are all related to a precipitation type soldering composition. All of the proposals suggested in (i) to (v) are respectively accompanied with problems.

For example, in the case of electroless nickel plating, it is impossible to avoid the generation of residual phosphor in the process of forming the nickel plating, thus raising problems on the occasion of performing the soldering due to this residual phosphor. When soldering is to be performed using the aforementioned precipitation type soldering composition (solder paste), the solder paste is coated all over the surface of printed wiring board and heated to precipitate a metal on the circuit pattern, thereby forming a soldered layer. However, the metal is permitted to precipitate even at the non-circuit portions, giving rise to the generation of short circuit of the wiring circuit. In order to avoid such a problem, special kinds of organic complexes as shown in the above items (iv) and (v) are required to be employed. Further, when a flux incorporated with a metal salt of organic acid is employed, the metal is caused to react with the metal in the solder, permitting a substitution reaction to take place. The probability of generating this substitution reaction would be increased as the ionization tendency of the metal in the solder becomes higher. If this substitution reaction happens to take place, the viscosity of the solder paste is more likely caused to fluctuate, thus not only deteriorating the storage stability of solder but also deteriorating the wettability and spreadability of solder paste.

In summary, any of these publications fail to disclose, as a flux for performing the ordinary soldering (not only in the soldering using a precipitation type solder composition but also in the ordinary soldering using a non-precipitation type solder composition) using a lead-free and zinc-free solder containing neither lead nor zinc, such a kind of flux that contains copper-based metal, nickel-based metal or inorganic ester of these metals, or such a kind of flux that contains organic complexes which are set forth in the aforementioned publications (iv) and (v) or that contains other kinds of organic complexes or inorganic complexes which are more convenient for use than the aforementioned organic complexes. The same may be said of a flux for performing soldering using a precipitation type solder composition. Additionally, any of these publications fail to disclose a solder paste of lead-free or zinc-free solder containing no lead or zinc, which can be obtained through the employment of the aforementioned fluxes. By the way, a preflux to be coated on the metal of soldered portion in the soldering for preventing the metal from being rusted can be distinguished from the flux to be employed as a pretreatment in an in-line soldering process. With respect to this preflux also, any of these publications fail to disclose those containing any of the metals or metallic compounds set forth in the aforementioned publications (i) to (v), much less about the addition of other kinds of metals or metallic compounds.

### SUMMARY OF THE INVNETION

The present inventors have found, as a result of intensive studies for solving the aforementioned problems, that it is possible, through the employment of a flux containing copper, nickel or a compound of these metals, in particular, through the employment of a preflux or a flux each containing an activating agent together with copper, nickel or a compound of these metals, to enhance the wettability and soldering strength to the soldered portion of copper-based solder of lead- and zinc-free type. Further, it has been found that a solder paste of lead- and zinc-free solder where the aforementioned flux is employed is excellent in stability and capable of decreasing the content of the activating agent and also capable of improving the corrosion resistance or insulation resistance of residual film. Furthermore, it has been found that, when a fluorinated compound is additionally incorporated in the flux, the aforementioned properties can be further improved, thus accomplishing the present invention.

Namely, according to the present invention, there is provided (1) a preflux which is designed to be used in soldering using a lead-free solder containing tin as a major component and not containing lead, wherein the preflux contains at least one kind of material selected from the group consisting of an inorganic salt of copper-based metal and/or a nickel-based metal, an inorganic complex of copper-based metal and/or a nickel-based metal, an organic complex of copper-based metal and/or a nickel-based metal, and an organic ester of copper-based metal and/or a nickel-based metal.

According to the present invention, there is also provided (2) a flux which is designed to be used in a soldering using a lead-free and zinc-free solder containing tin as a major component and not containing lead, the soldering being adapted to be applied to a surface portion which is constituted by a copper-based metal and/or a nickel-based metal (excluding the case where the surface portion is constituted by electroless nickel plating), wherein the flux contains at least one kind of material selected from the group consisting of a copper-based metal, a nickel-based metal, an inorganic salt of copper-based metal and/or a nickel-based metal, an inorganic complex of copper-based metal and/or a nickel-based metal, and an organic complex of copper-based metal and/or a nickel-based metal (a metal complex of an organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal).

According to the present invention, there is also provided (3) the flux as set forth in the aforementioned item (2), which is designed to be used in a soldering using a lead-free solder containing tin as a major component, containing zinc and not containing lead, the soldering being adapted to be applied to a surface portion which is constituted by a copper-based metal and/or a nickel-based metal (excluding the case where the surface portion is constituted by electroless nickel plating), wherein the flux contains 0.01 to 8% (as reduced to metal) of at least one kind of material selected from the group consisting of a copper-based metal, a nickel-based metal, an inorganic salt of copper-based metal and/or a nickel-based metal, an inorganic complex of copper-based metal and/or a nickel-based metal, and an organic complex of copper-based metal and/or a nickel-based metal (a metal complex of an organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal).

According to the present invention, there is also provided (4) the flux as set forth in the aforementioned items (2) or (3), which contains at least one kind of material selected from the group consisting of an organic acid, amine, an organic amine salt, amine halogenate, amine hydroborofluoride, amine trifluoride/boron complex salt, and organic halides.

According to the present invention, there is also provided (5) the flux as set forth in the aforementioned item (4), which further contains a resin component.

According to the present invention, there is also provided (6) the preflux or flux as set forth in the aforementioned items (1) to (5), which is adapted to be employed in a printed wiring board.

According to the present invention, there is also provided (7) a solder paste to be obtained using the flux of any one of the aforementioned items (2) to (6).

According to the present invention, there is also provided (8) the solder paste as set forth in the aforementioned item (7), wherein the solder paste to be obtained by making use of a flux containing a copper-based metal and/or a nickel-based metal is obtained by making use of coated solder powder which can be obtained by coating lead-free solder powder containing tin as a major component and not containing lead with a copper-based metal and/or a nickel-based metal.

According to the present invention, there is also provided (9) a method of manufacturing a soldered body by making use of a lead-free or lead-free/zinc-free solder wherein the preflux, the flux or the solder paste as set forth in any one of the aforementioned items (1) to (8), the method being featured in that, by making use of heat at the time of soldering or by making use of an activating agent (if the activating agent is employed), the metal and/or the metal compound are activated to enable the activated substance to exist on the surface of the metal or at the soldering portion, thereby enabling an intermetallic compound to generate at the soldering portion to enhance the wettability of fused solder and/or to prevent the deterioration of bonding strength of solder due to an excessive growth of the intermetallic compound.

### BRIEF DESCRIPTION OF THE SEVERAL VIEWS OF THE DRAWING

FIG. 1 is a graph illustrating the results of solder spreadability test using lead-free solders wherein a flux of one example of the present invention was employed.

### DETAILED DESCRIPTION OF THE INVENTION

The present invention has been accomplished based on the following facts.

(i) In the conventional Sn—Pb-based soldering, the role of the flux is to remove the surface oxides of the matrix metals of solder and soldering substrate, to prevent the re-oxidation at the time of soldering, and to lower the surface tension of solder, thereby obtaining sufficient wettability.

The reasons for these phenomena can be explained as follows.

(i)-1: Rosin, organic acid, amine hydrochloride and zinc chloride included in the flux are enabled to react with the copper oxide on the surface of copper, for example, constituting a matrix metal according to the reaction formulas (1) to (4) shown below, thereby entrapping the copper oxide in the resultant compounds, thus enabling the surface of copper to expose and hence to clean the soldering surface.

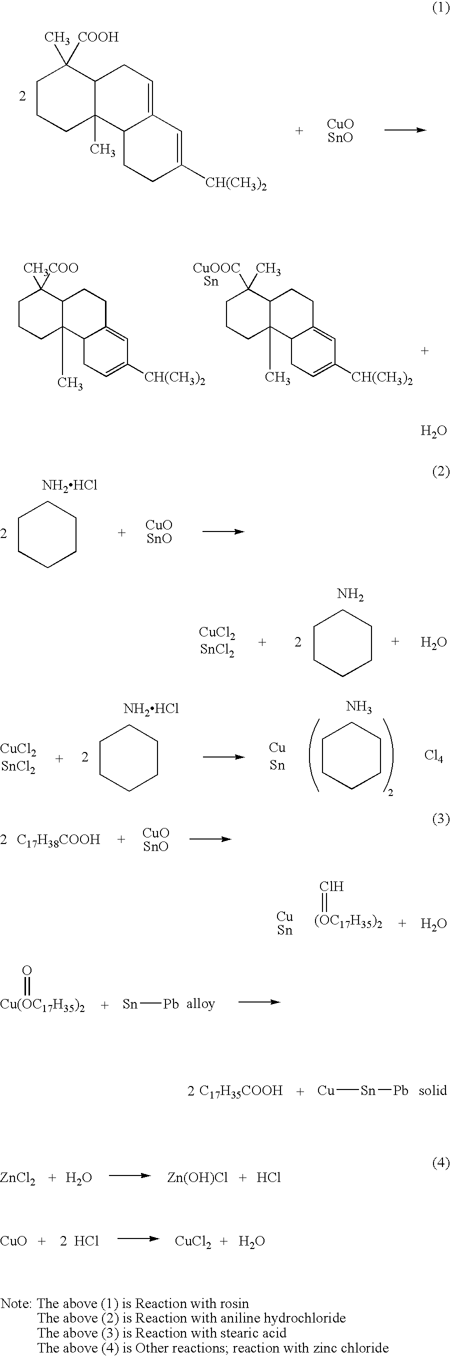

(i)-2: Next, the reaction products thereof with copper oxide (copper rosinate, organic copper ester, copper chloride, copper amine complex) are enabled to react with fused solder, thereby giving metal copper in the solder.

(i)-3: The copper thus produced is enabled to immediately dissolve in the fused solder, thereby wetting the copper surface with the fused solder. On this occasion, an intermetallic compound of Cu—Sn is permitted to generate on the surface of the matrix copper, thereby making the fused solder more wettable to the surface of the matrix copper. At the same time, due to Pb component, the fluidity of the fused solder is promoted and the surface tension thereof is lowered. As a result, concurrent with the extensive and rapid formation of the intermetallic compound on the surface of matrix copper, the fused solder is made easier to spread and more wettable.

(i)-4: When it is tried to employ a flux containing an activating agent excellent in spreadability to the matrix metal copper and incorporated with a reaction product to be derived from the reaction between amine hydrochloride and copper oxide shown in the above reaction formula, the spreadability (wettability) of solder tends to deteriorate.

(i)-5: When it is tried to employ a flux containing an activating agent excellent in spreadability to the matrix metal copper together with amine hydrochloride, the spreadability of solder tends to deteriorate in proportion to the decrease of lead. However, when copper chloride, copper amine complex and organic copper ester are added to the flux, the spreadability of solder would be enhanced.

(i)-6: This tendency would become prominent when the content of Sn is 100%.

The foregoing explanations are directed to the studies on the mechanism of the effects of flux. However, the employment of the flux is accompanied with the following problems.

(a) It is impossible to uniformly wet the matrix metal or solder with the activating agent or the activating agent/metal compound which is a reaction product between the activating agent and copper oxide of the matrix metal copper. Therefore, it is impossible to prevent the reoxidation of the matrix metal or solder if the quantity of the flux to be employed is relatively small.

(b) The activating agent and the activating agent/metal compound are hardly compatible with each other at a soldering temperature.

(c) The activating agent/metal compound would obstruct the wettability of solder unless they are brought into a molten state or a dissolved state at least at a soldering temperature.

(d) Since the activating agent is hygroscopic in air atmosphere, the scattering of flux would be caused to generate due to sudden volatilization of the absorbed water on the occasion of soldering.

(e) Due to the phenomena mentioned in above items (a) to (d), the coating of flux may become uneven, so that the solder may spread ununiformly, thereby allowing the peripheral portion (i.e. excluding the central portion) of fused solder being applied to partially spread very thinly as if the solder has been oozed out.

(As for the aforementioned items (i)-5 and (i)-6, see the description set forth in pages 271-275 of the Japanese Chemical Society Report, 1973).

(ii) Whereas, even if the same kind of flux as described above is employed in a lead-free solder, the following problems would be raised.

(ii)-1 Since Pb component is not included in the solder, it would be impossible to increase the fluidity of fused solder and to lower the surface tension. As a result, it is impossible to form the intermetallic compound Cu—Sn extensively and quickly on the surface of matrix copper and moreover, the growth of the intermetallic compound would be obstructed. Furthermore, the fused solder itself is poor in spreadability and in wettability.

(ii)-2 If Sn component is employed as a major component, the diffusion of copper into the fused solder would become too fast to initiate the formation of an intermetallic compound Cu—Sn on the surface of the matrix copper.

(ii)-3 The activating agent of the flux would be consumed for the reaction thereof with tin oxide which is highly oxidizable, so that the activating agent cannot be employed in the reaction thereof with a copper compound, making it impossible to smoothly execute the processes of aforementioned items (i)-2 and (i)-3.

(iii) Because of the aforementioned problems, it is required, in order to enable the solder to spread extensively, quickly and uniformly, to select a flux which makes it possible to create a molten or dissolved phase of the aforementioned activating agent/metal compound component on the occasion of soldering, to additionally employ other kinds of activating agent to create the aforementioned molten or dissolved phase of the aforementioned activating agent/metal compound component, or to additionally employ other kinds of resinous components and solvent components (for example, rosin-based resin, water-soluble resin, polyhydric alcohols such as glycerin and polyethylene glycol). If rosin-based flux is to be employed, it is desirable to employ the activating agent/metal compound which is soluble in a solvent such as alcohol. By doing so, even if the adding quantity of the activating agent for flux and the contents of the metal and metal compound are reduced, it is now possible to realize excellent solder-wettability through the employment of a flux which is excellent in corrosion resistance and insulating property. Namely, it has been found out that since the lead-free solder containing Sn as a major component is accompanied with the problem that it is difficult to enable an intermetallic compound Cu—Sn to be formed extensively an quickly on the surface of matrix copper, it is useful to incorporate copper or a copper compound into the flux to promote the formation of the intermetallic compound Cu—Sn, thereby enabling the intermetallic compound Cu—Sn to be readily, extensively and quickly formed on the surface of matrix copper.

(iv) Based on the findings, it has been found out that, in the soldering using a lead-free solder, it is useful to incorporate at least one kind of material selected from specific kind of metal and metal compound into the flux and to disintegrate the flux by making use of soldering heat on the occasion of soldering, the metal or metal compound being selectively disposed at the interface between the solder and the matrix of substrate being soldered to enable the intermetallic compound to be formed at the soldering region through the utilization of the soldering heat or of the interaction between other components and an organic activating agent, thereby making it possible to promote or suppress the formation of the intermetallic compound, to enhance the solder-wettability, or to suppress the excessive growth of the intermetallic compound.

The flux (including flux to be employed in a solder paste, the same hereinafter) may contain at least one kind of material selected from metal and metal compound, the metal being Sn, Pb, Cu, Ag, Bi, Zn, Ni, Fe, Al, Li, Mg, St or Sb. If the metal (matrix metal) of a surface portion of substrate being soldered with solder is constituted by a copper-based metal (i.e. copper or copper alloys, the same hereinafter) or a nickel-based metal (i.e. nickel or nickel alloys, the same hereinafter) it is preferable to employ a copper-based metal, a nickel-based metal or a compound of these metals, more preferably, the same kinds of metal or compound. In the case of the flux for use in the lead-free solder, it is possible to enhance the solder-wettability and the bonding reliability by incorporating therein at least one kind of the same kind of metal or metal compound as that of the soldering portion (matrix metal) of the soldering substrate.

As for specific examples of the “metal compound” to be incorporated in a preflux or flux, they can be classified into inorganic metal compounds and organic metal compounds. As for the inorganic metal compounds, it is possible to employ mineral acid salts of the aforementioned metals. As for the mineral acid, examples of which include hydrofluoric acid, hydrochloric acid, phosphoric acid, hydrobromic acid, hydroborofluoric acid, etc. As for the organic metal compounds, it is possible to employ metal salts of organic acid and of the derivatives of organic acid, metal salts of chelate compound, and organometallic compound. As for the metal salts of organic acid and of the derivatives of organic acid, specific examples of which include reaction products formed between metals and various kinds of compounds having carboxyl group, e.g. saturated or unsaturated carboxylic acids, polybasic carboxylic acid, halogenated fatty acid, halogenated aromatic carboxylic acid, oxycarboxylic acid, amino acid, aromatic carboxylic acid, etc. Specific examples carboxylic compounds are as follows. By the way, rosin (containing 1-abietic acid as major component) and the derivatives thereof (for example, polymerized rosin, disproportionated rosin, phenol-modified rosin, maleic acid-modified rosin, etc.) are most representative examples to be employed in the flux, and the aforementioned metal salts can be also employed.

As for the fatty acid, specific examples of which include acetic acid, caprylic acid, propionic acid, myristic acid, palmitic acid, arachidic acid, linolic acid, oleic acid, stearic acid, capric acid, etc. As for the polybasic carboxylic acid, specific examples of which include oxalic acid, malonic acid, succinic acid, adipic acid, sebacic acid, etc. As for the halogenated fatty acid, specific examples of which include monochloroacetic acid, dichloroacetic acid, trichloroacetic acid, α-chloropropionic acid, etc. As for the halogenated aromatic carboxylic acid, specific examples of which include 2-bromophenyl acetic acid, 3-bromophenyl acetic acid, 3-bromo-4 methyl benzoic acid, 3-bromophenyl acetic acid, etc. As for the aromatic carboxylic acid and oxycarboxylic acid, specific examples of which include p-butyl benzoic acid, lactic acid, glycolic acid, malic acid, gluconic acid, p-hydroxy benzoic acid, 5-hydroxyisophthalic acid, etc. As for amino acid, specific examples of which include glycine, alanine, serine, cystine, phenyl alanine, glutamic acid, lysine, etc. As for the metal salts of chelate compound, specific examples of which include amine metal chelate compound (copper of lower alkylene diamine such as ethylene diamine, an organic complex of nickel, etc.) and halides thereof, ethylene diamine tin tetraacetate, and chelate compounds with azoles such as imidazoles such as benzimidazole, benzotriazole (for example, chelate compounds with 2-n benzylimidazole, 2-n undecylbenzimidazole, 2-(2-phenylethyl)benzimidazole, 2-cyclohexyl benzimidazole, 2-cyclohexyl imidazole, etc.). It is also employ inorganic salts of metal complexes to be produced through a reaction between amine inorganic salts and metals, as well as inorganic complexes between metallic ions and NH₃( ), H₂O, CN⁻, Cl⁻, F⁻, NCS⁻, etc. As for organometal compound, specific examples of which include compounds formed of a bonded body between a metal atom and carbon atom, such as tin tetraethyl, tin triethylisopropyl mercapto, tin tribenzyl chloride, lead tetraethyl, tin dibutyl dichloride, etc.

In the case of a solder paste to be obtained through the employment of flux containing a metal salt of organic acid, the metal salt of organic acid is highly reactive with lead-free solder powder such as tin powder, especially zinc powder. As a result, the viscosity of the solder paste is caused to change with time, so that even when this solder paste is employed in a reflow soldering, the wettability of fused solder would be deteriorated. In order to avoid this problem, a flux, especially, a flux for solder paste may include at least one kind of material selected from a metal, an inorganic salt of metal, an inorganic complex of metal and an organic complex of metal, i.e. at least one kind of material selected from a metal and a metal compound. Especially, in such a case where a soldering portion (matrix metal) of soldering substrate is constituted by at least one kind of metal selected from copper-based metal and nickel-based metal, it is preferable that the flux includes, as said at least one kind material selected from a metal and a metal compound, at least one kind of metal selected from copper-based metal and nickel-based metal, or at least one kind of material selected from inorganic salts of copper-based metal and/or nickel-based metal, inorganic complexes of copper-based metal and/or nickel-based metal, and organic complexes of copper-based metal and/or nickel-based metal (a metal complex of an organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal). It is also possible to additionally employ metal salts of organic acids and those to be activated by the soldering heat or an activating agent. In this specification, amine is intended to include primary amine, secondary amine and tertiary amine. Although the group to be coordinated may also include carboxyl group in addition to the aforementioned groups, there will be raised a problem of storage stability of solder paste as in the case where an organic acid is employed. Further, it is also utilize thioether group. A metal complex of organic compound having any of these groups may be also additionally employed. The material to be employed singly or in combination in a flux can be also employed singly or in combination in a preflux. Since the inorganic salt of metal can be easily dissolved in an aqueous solvent or alcohol, since the residue thereof can be easily washed, and since the inorganic salt of metal is relatively low in molecular weight and content of metal is relatively large, it can be effectively and easily employed. The same tendencies as described above are also recognized in inorganic complex of metal. The organic complex is preferable in the respects that the metal complex of organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal is easily available, that it is possible to select those having a relatively low molecular weight, that it can be easily disintegrated and evaporated by the soldering heat, and that it is possible to select those of relatively low cost.

In addition to those mentioned above and to the compounds described in the following examples, it is possible to employ pigments and metal complexes of organic compounds, especially, metal complexes of copper and nickel. More specifically, it is possible to employ pigments for optical information recording medium or additives thereof. For example, it is possible to employ those described in JP Laid-open Patent Publication (Kokai) No. 63-276593 (1988) (metal-containing quinolin-dione-based compounds, etc.), JP Laid-open Patent Publication (Kokai) No. 3-93592 (1991), JP Laid-open Patent Publication (Kokai) No. 64-50252 (1989), JP Laid-open Patent Publication (Kokai) No. 8-310129 (1996), JP Laid-open Patent Publication (Kokai) No. 2-76884 (1990)(metal-containing pyridophenothiazine-based compound, etc.), JP Laid-open Patent Publication (Kokai) No. 4-292260 (1992), JP Laid-open Patent Publication (Kokai) No. 8-295079 (1996)(formazan metal complex-based pigment, etc.), JP Laid-open Patent Publication (Kokai) No. 9-323478 (1997)(metal-containing azo-based compound, etc.), JP Laid-open Patent Publication (Kokai) No. 5-17701 (1993)(metal ion-containing indoaniline-based pigment, metal ion-containing indophenolic pigment compound, etc.).

Among the aforementioned metals and metal compounds, those which are most effective in enhancing the wettability of lead-free solder are Cu (copper) and compounds thereof. The second best to the Cu (copper) and compounds thereof are Ni (nickel) and compounds thereof. With regard to other kinds of metals, when they are employed singly, the effects thereof are inferior than those of a copper compound, and therefore, it is preferable to employ these metals at a least necessary quantity as means for generating an intermetallic compound of copper while suppressing the excessive growth of intermetallic compounds of other components (excluding tin) included in the lead-free solder. With regard to other metals also, the inclusion thereof in a flux would be effective in enhancing the wettability of solder if the metal to be included in the flux is useful in generating an intermetallic compound between the matrix metal and Sn. For example, when the matrix metal is nickel, Ni or a compound thereof can be included in the flux, when the matrix metal is iron, Fe or a compound thereof can be included in the flux, when the matrix metal is 42-alloy, Fe, Ni or a compound thereof can be included in the flux, thereby making it possible to enhance the wettability of solder. The inclusion of these metals or compounds is effective in preventing the deterioration of bonding strength of solder that may be caused due to excessive growth of intermetallic compound under a high-temperature environment, i.e. a drawback involved in the employment of the lead-free solder. Namely, even to metals which may become barrier against the growth of intermetallic compound such as nickel and nickel-iron alloy as shown in INTERNATIONAL TIN RESEARCH INSTITUTE Publication No. 631, the flux of the present invention is effective in enhancing the wettability of solder, so that, even if soldering is to be applied to a nickel-plated surface formed on a copper layer of a printed wiring board for instance, it is possible, with the employment of the flux of the present invention, to obtain almost the same quality of soldered portion as that obtainable in the employment of the conventional rosin-based flux. As a result, it is possible to enhance the reliability of solder bonding and to suppress the excessive growth of intermetallic compound which may be caused to occur under a high-temperature environment. When Ni or Fe is included in a flux, it is possible, in the soldering of the ordinary printed wiring board, to expect almost the same effects as described above through the formation of an intermetallic compound between Sn and Cu, Fe or Ni. Furthermore, the flux of the present invention can be also employed for preventing the phenomenon of so-called solder-eating where the plated metal is caused to fuse away in the case where the lead wires or electrodes of electronic parts are plated with copper, silver or gold. Namely, by incorporating these metals into the flux, it is possible to prevent an excessive penetration of fused plating metal into a solder that may be caused to occur on the occasion of soldering. Especially, the flux containing a metal such as Fe, Ni, Cu, Au or Ag or a metal compound containing these metals is effective in this respect.

For the purpose of preventing an Sn—Bi-based solder from segregating into the interface of soldering that may become a cause for generating a lift-off phenomenon, a metal such as Fe, Ni, Cu, Au or Ag or a metal compound containing these metals may be incorporated into the flux so as to enable an intermetallic compound of these metals to be generated at the interface of solder, thereby making it possible to achieve the aforementioned object.

By the way, although Pb and compounds thereof are also effective in enhancing the wettability of lead-free solder, the employment of them may be restricted in the aspect of environmental countermeasure. Among the metallic compounds, most of metallic compounds, excluding inorganic metal salts and halogenated chelate compounds, are weak in action of reducing oxide film, so that an organic acid-based activating agent or an organic amine-based activating agent may be additionally employed, thereby easily enhancing the reducing action. As long as a metallic compound is capable of being activated on the occasion of soldering, it can be employed in combination with an activating agent to obtain the reducing action of oxide film even if the metallic compound is not provided with soldering effects as in the case of a metal, a metal oxide and an organic metal compound. Therefore, these materials may be added to a flux or to a solder paste after they have been pulverized into powder. These materials may be mixed with solder powder while avoiding these materials from being alloyed with a solder. However, if copper is alloyed in the solder, it would become impossible to obtain the aforementioned reducing effects.

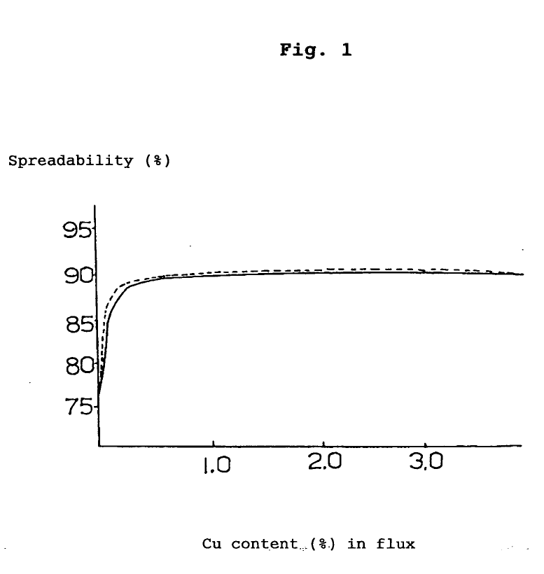

With respect to the mixing ratio of at least one kind of the aforementioned metal and metal compound (which may be referred to as “metal or metal compound” and wherein the metal includes at least one kind of metal selected from copper-based metal and nickel-based metal; and the metal compound includes compounds of copper-based metal and nickel-based metal, especially inorganic salts of copper-based metal and nickel-based metal, inorganic complexes of copper-based metal and nickel-based metal, organic complexes of copper-based metal and, nickel-based metal (metal complexes of organic compounds where atoms of N, O and S in amine (excluding nitrogen-containing hetrocyclic compounds), imine (excluding nitrogen-containing hetrocyclic compounds), oxime, ketone, alkoxy and thioketone are coordinated with a metal)), even if the mixing ratio is small, it is possible to obtain the aforementioned effects though it depends on the kind of other activating agents to be included in the flux. However, if the mixing ratio is increased further, the wettability of solder tends to be gradually lowered. FIG. 1 illustrates the results of experiments on the spreadability of the lead-free solders which were obtained using rosin-based fluxes containing varied quantities of copper compounds. As seen from FIG. 1, the spreadability was sharply increased to a peak as copper compounds were incorporated into the flux and then the spreadability was equilibrated. In the case of FIG. 1, the copper compound was formed of metal copper and a preferable mixing range of the copper compound in the flux was 0.01-3% (mass %, the same hereinafter) (when measured as metal). As seen from FIG. 1, it is possible to determine an optimum mixing ratio based on the curve of the spreadability of solder which was obtained from the solder spreadability test using fluxes containing varied mixing ratios of metal or metal compound. By the way, the mixing ratio of metal or metal compound into the flux is required to be altered depending on the kind of activating agent to be additionally employed. For example, in the case of FIG. 1, when the flux was employed in combination with an activating agent such as amine hydrochloride, the reaction rate of the activating agent to the copper oxide (CuO) or copper compound of the matrix metal copper was varied depending on the kind of amine. A suitable range of the content (measured as metal) of at least one kind of material selected from metal and metal compound in the flux is generally confined within the range of 0.01 to 8%.

One kind or several kinds of the metal or the metal compound will be incorporated into the flux by taking into consideration the kind of solder, soldering temperature, solubility, wettability of solder, decomposition temperature, the reliability of residual flux, the content of metal, harmfulness, etc. The mixing ratio of the metal or the metal compound will be adjusted also taking these factors into consideration. The mixing ratio of the metal or the metal compound into the flux can be optionally determined from the molecular formula thereof. For example, the content of metal in metal salt of stearic acid would be 2.5% for lithium, 11.3% for copper, 4.5% for magnesium, 13.8% for strontium, 20.0% for barium, 10.6% for zinc, 5.3% for aluminum (mono), 27.0% for lead, and 8.8% for nickel. By the way, when a flux containing organolead compounds is to be employed, lead should be included only in the alloy layer of solder-bonded portion and the content of lead in the solder should be confined to lower than the specified ratio of impurity of lead-free solder based on the entire body of bonding solder, thus limiting the content of lead to such a level that would not raise any problem. However, since the residual flux contains lead, it is preferable to wash out the residual flux when environment contamination as the soldered product is abolished is taken into account. It has been found out that, since a flux containing a metal or a metal compound can be quickly decomposed as the flux is contacted with fused solder thereby transforming the metal or the metal compound into metal oxide, it is possible, even if residual flux is caused to fall into a solder tank, to actually avoid the contamination of solder that may be caused due to the penetration of the metal or the metal compound of the flux into fused solder on the occasion of soldering using a flux containing a metal or a metal compound.

In the present invention, the flux may contain a resin component such as rosin-based resin, acrylic resin, silicone resin and water-soluble resin. This water-soluble resin may be those that are alkali-soluble such as ammonia or amine-soluble. As for other kinds of the water-soluble resin, they include polyalkylene glycol such as polyethylene glycol and ethylene oxide adduct. As for the flux containing a resin component, specific examples of which include those comprising a rosin-based resin as a base component to which at least one kind of activating agent selected from the group consisting of an organic acid, amine, amine salt of organic acid, amine halogenate, amine hydroborofluorate, amine boron trifluoride complex salt, and organic halide. If required, a solvent may be incorporated into the flux. As for the rosin-based resin, specific examples of which include at least one kind selected from rosin and derivatives thereof, more specifically, at least one kind selected from polymerized rosin, hydrogenated rosin, phenol-modified rosin and disproportionated rosin. Rosin to which amine is partially added (preferably, a half of the rosin-based resin should be left in an unreacted state) is also preferable. The mixing ratio of the resin component should preferably be confined to 3-30% in the case of liquid flux, and 40-60% in the case of flux for solder paste. When polyalkylene glycol is to be employed, it can be employed in the same manner except the mixing ratio thereof. Namely, the mixing ratio of the polyalkylene glycol should preferably be confined to 5-50% in the case of liquid flux, and 50-90% in the case of flux for hot air leveler. As for amine, specific examples of which include aliphatic amine such as alkyl amine, alkylene amine, alkylalkanol amine; heterocyclic amine such as pyridine, imidazoline, imidazole and triazole; and aromatic amine such as aniline and toluidine. As for amine salt, it is possible to employ halides thereof and the mixing ratio thereof should preferably be confined to 0.2-3% based on the rosin-based resin. As for fluorides and borofluorides, it is possible to employ hydrofluoric acid salt with amine and borofluoride, respectively, the preferable mixing ratio thereof being not more than 10%, more preferably 0.2-3%. If required, it is also possible to incorporate, other than the compounds mentioned above, known activating agents such as organic halides, various kinds of chelate compounds, organic acids, etc.

As for the solvent, it is possible to employ lower alcohols such as isopropylalcohol, ethyl alcohol, etc.; Cellosolve; glycols; etc.

By the way, it is possible to employ any of the aforementioned conventional fluxes.

The aforementioned fluxes of the present invention can be employed as a rosin-based flux for ordinary electronic equipments, as a flux for pine-containing solder or automatic soldering, or as a flux for solder paste (i.e. for use in a solder paste which can be obtained by mixing lead-free solder powder with other component such as solvent as required, the resultant mixture being subsequently formed into paste). Further, the fluxes of the present invention can be applied to various kinds of non-rosin type flux. It is possible to enhance the wettability and bonding strength of fused lead-free solder by employing the flux in such manners that the rosin-based resin included in a preflux for printing wiring board is caused to react with a metal such as silver, that at least one kind selected from a metal such as copper and a metal compound such as a copper compound is incorporated into the preflux, or that a metal compound such as a copper compound is coated as it is on the surface of the copper foil land of a printed wiring board. As for the flux for printed wiring boards, the employment of copper or a copper compound is preferable. If it is desired to employ a metal compound such as a copper compound as it is as a coating type preflux, it is preferable to employ copper salts of organic acids having a softening point ranging from 60° C. to 150° C. such as rosin-based resin, stearic acid, palmitic acid, para-tertiary butyl benzoic acid, etc. With respect to other kinds of metals, it is possible to employ the same kinds of compounds as described above. If it is desired to protect metals other than copper or if it is desired to improve the wettability of solder to metals other than copper, it is preferable, in order to enhance the effects thereof, to incorporate the metals or compounds thereof in the flux. These metals and metal compounds may be employed as a preflux to be employed in a pre-step for coating the ordinary flux prior to the soldering in an automated line. The content of copper in a coated film would be about 10% as clear from the molecular weight thereof when it is employed as a salt of rosin or higher aliphatic acid for example. Since the film coated is thin, the metal or metal compound to be included in the flux at a higher ratio than that of ordinary soldering flux. Specifically, the content of the metal or metal compound to be included in a preflux should preferably be confined to the range of about 0.1 to 15.0% when calculated as metal. By the way, with respect to the metals other than copper, it is possible to employ them by taking the soldering properties into consideration. Further, if it is desired to employ the metals as a preflux, it may be employed without incorporating the aforementioned activating agents.

By the way, the preflux can be employed in combination with a coating agent for protecting the copper foil of printed wiring board wherein azole compound such as benzotriazole-based compound is employed. The preflux and the coating agent can be employed as a mixture comprising them at a suitable ratio.

As for specific examples of the lead-free solder of the present invention, they include, for example, Sn—Ag—Bi, Sn—Cu, Sn—Zn—Al, Sn—Ag, Sn—Cu, Sn—Ag—Bi, Sn—Bi, Sn—Ag—Bi—Cu, Sn—Ag—Cu—In, Sn—Ag, Sn—Ag—Cu, Sn—Cu—Ni, Sn—Sb, Sn—In, Sn—Zn, etc. It is also possible to incorporate other kinds of metals to these solders.

According to the present invention, there are provided a preflux, a flux and a lead-free solder paste, each containing at least one kind of material selected from metal and metal compound, especially, at least one kind of material selected from copper-based metal, nickel-based metal and the compounds thereof, these fluxed and paste being designed to be employed in the soldering using a lead-free solder. Since at least one kind of these metal and metal compound can be employed in combination with an activating agent in a flux containing a rosin-based resin, it is possible to enhance the wettability of lead-free solder to a matrix metal of the soldering portion and to enhance the bonding strength of soldered portion. Especially, when a amine-based activating agent, particularly a fluorine-/amine-based activating agent is employed, the aforementioned effects can be further enhanced. When the aforementioned copper-based metal or compounds thereof are employed in combination with an amine-based activating agent, particularly a fluorine-/amine-based activating agent in the flux, it is possible to enhance the wettability of fused lead-free solder to a copper foil and a through-hole, and to enhance the bonding strength of soldered portion, even if the lead-free solder is employed for soldering the electrode of chip component or the lead wire of electronic parts to the copper foil land and the through-hole by means of dipping or jet flow soldering method or even if the lead-free solder is employed as so-called solder paste wherein lead-free solder powder is mixed, as required, with other components such as solvent. This soldering process can be performed without necessitating modification of the ordinary soldering conditions of lead-free solder and hence the present invention is very valuable in industrial viewpoint. Moreover, since the aforementioned copper-based metals and the compounds thereof can be selected from those which are easy to use and these metals and compounds are employed together with a lead-free solder containing no zinc which is highly reactive with activating agents, thus forming a solder paste, it is possible to enhance the practicability without badly affecting the storage stability and solder-wetting stability.

Since the wettability of lead-free fused solder can be enhanced through the formation of a flux layer comprising the aforementioned metals or metal compounds, it is possible to realize excellent solder-wettability and excellent corrosion resistance and insulating property of residual flux even if the content of the activating agent in the flux is reduced.

The solder paste comprising a preflux, a flux and a lead/zinc-free solder paste, each containing at least one kind of material selected from copper-based metal, nickel-based metal and the compounds thereof, and further containing an active agent or a resin component as required, can be employed in lead-free soldering while making it possible to enhance the wettability of -fused lead-f ree solder to a matrix metal and to enhance the bonding strength of soldered portion without necessitating modification of the ordinary soldering conditions of lead-free solder.

### EXAMPLE 1

Various kinds of fluxes were prepared and by making use of them, the wettability of various kinds of metal compounds was compared with each other.

19% (mass %, the same hereinafter) of rosin, 5% of polymerized rosin, 1% of ethylene amine hydrobromate (activating agent), 3% of various kinds of metal compounds (calculated as metal) and the balance of ethyl alcohol (100% in total) were mixed together and stirred to obtain a flux. By making use of this flux, solder spreadability test (the flux was coated on the surface of a copper-clad laminate to form a layer of flux on which a fused solder was applied drop-wise to measure the spreadability (%) of the solder) was performed based on JIS-Z-3197, the results being illustrated as follows.

By the way, the following (A) to (E) represent the compositions of the solders shown below.

| | | | |
|---|---|---|---|
| (A) 96.5Sn-3.0Ag-0.5Cu | melting point: | 217° | C. |
| (B) 99.3Sn-0.7Cu | melting point: | 227° | C. |
| (C) 96.5Sn-3.5Ag | melting point: | 221° | C. |
| (D) 91.2Sn-8.8Zn | melting point: | 298.5° | C. |
| (E) 58Sn-42Bi | melting point: | 139° | C. |
| (F) 63Sn-37Pb (Comp. Ex.) | melting point: | 183° | C. |

| | (A) | (B) | (C) | (D) | (E) | (F) |
|---|---|---|---|---|---|---|
| Without metal compound (Comp. Ex.) | 78 | 78 | 76 | 75 | 85 | 93 |
| Copper hydroxide | 86 | 86 | 86 | 85 | 88 | 93 |
| Copper chloride | 89 | 89 | 88 | 86 | 90 | 93 |
| Copper bromide | 89 | 89 | 88 | 86 | 90 | 93 |
| Nickel chloride | 85 | 85 | 85 | 83 | 85 | 85 |
| Copper phosphate | 86 | 86 | 86 | 84 | 86 | 92 |
| Copper borofluoride | 85 | 85 | 85 | 83 | 85 | 92 |
| Copper ammonium chloride | 86 | 86 | 86 | 85 | 86 | 93 |
| Copper chloride/amine complex | 88 | 88 | 88 | 85 | 88 | 93 |
| (Cu(RNH₃)₂Cl₄; wherein R is benzene | | | | | | |
| ring; and RNH₃ is aniline) | | | | | | |
| Copper dimethyl glyoxime | 86 | 86 | 86 | 85 | 86 | 93 |
| Copper acetyl acetone | 86 | 86 | 86 | 85 | 86 | 93 |

Note:
(A) to (C) and (E) represent respectively a lead-free solder, (D) represents a lead/zinc-free solder, and (F) represents a lead-containing solder.

Herein, by making use of rosin-based flux for printed wiring board while varying the content of copper (% as metal copper in the flux) through the change of the content of copper chloride, the soldering using a lead-free solder (96.5Sn-3.0Ag-0.5Cu) (melting point: 217° C.) was performed to measure the spreadability of the solder based on JIS-Z-3197, the results being illustrated by a dot line in the graph of FIG. 1.

It will be seen from these results that it was possible, through the incorporation of a copper compounds and nickel compound in the fluxes, to improve the wettability of lead/zinc-free solder.

By the way, in the case of the compound containing no halogen such as copper chloride, copper dimethyl glyoxime and copper acetyl acetone (the same in the case of metal salt of organic acid which was added to the preflux of following Example 2), it was difficult to enhance the spreadability of solder unless the activating agent was not additionally employed. However, in the case of copper salt of inorganic acid containing halogen such as copper chloride, it was possible to enhance the spreadability of solder even if the activating agent was not additionally employed, thereby indicating that the copper salt of inorganic acid acted also as an activating agent. It will be understood from these results that inorganic halogen salt, halogen salt of inorganic complex (halogen salt of at least one kind selected from copper-based metal and nickel-based metal; and halogen salt of inorganic complex of at least one kind selected from copper-based metal and nickel-based metal) and halogen salt of organic compounds are all capable of acting as an activating agent.

### EXAMPLE 2

Examples of prefluxes for printed wiring board will be explained. The prefluxes employed herein can be said as an anti-rusting agent.

Prefluxes formed of a 20% ethyl alcohol solution of the following compounds were prepared and then a copper plate was dipped in each of prefluxes and then dried. The copper plates were left to stand for 96 hours under the conditions of: 40° C. in temperature and 95% in relative humidity to visually observe the discoloration of copper plates. Then, by making use of the lead/zinc-free solder (A) of Example 1, solder spreadability test (solid flux was placed on the surface of copper plate and then a flux was coated thereon and heated to measure the spreadability (%) of the fused solder) was performed based on JIS-Z-3197, the results being illustrated as follows.

By the way, the flux employed was prepared by mixing, with stirring, 19% of rosin, 5% of polymerized rosin, 1% of ethylene amine hydrobromate (activating agent), and the balance of ethyl alcohol (100% in total).

| | | Spreadability |
|---|---|---|
| Compounds | Discoloring | (%) |
| Copper palmitate | None | 86 |
| Nickel palmitate | None | 84 |
| Copper stearate | None | 86 |
| Copper tert-benzoate | None | 86 |
| Rosin acid (70%) + | None | 86 |
| copper acetyl acetone (30%) | | |
| Copper rosinate | None | 86 |
| Nickel rosinate | None | 84 |
| Rosin (Comp. Ex.) | None | 78 |
| Untreated (Comp. Ex.) | Yes | 75 |

It will be seen from these results that the copper compounds were also provided with anti-rusting effects and the surface treated with the copper compounds was excellent in solder spreadability.

### EXAMPLE 3

One example where a flux was applied to a solder paste will be explained.

55% of rosin, 6% of hydrogenated caster oil (thixotropic agent), 1% of diphenyl guanidine (activating agent), 0.5% of 2,3-dibrome succinic acid, 0.3% of dimethyl amine hydrochloride, 5% of amine copper chloride complex (aniline copper chloride complex), 1% of nickel dimethylglyoxime, and the balance of carbitol (100% in total) were mixed together and stirred to obtain a flux.

10% of this flux and 90% of lead/zinc-free solder powder (96.5Sn-3.0Ag-0.5Cu)(10-50 μm in particle diameter) were kneaded together to obtain a solder paste. This solder paste was substantially free from changes in viscosity with time and hence excellent in storage stability.

When this solder paste was subjected to a spreadability test in the same manner as in Example 1, this solder paste was found more excellent in wettability and bonding strength as compared with those of a solder paste (comparative example) which was obtained from the same composition as described above except that the metal compounds (5% of aniline copper chloride complex and 1% of nickel dimethylglyoxime) were not included. Namely, when the solder paste of this example and the solder paste of the comparative example were subjected to solder spreadability test using copper, nickel and 43-alloy as a matrix metal, the following results were obtained.
Solder paste (Ex. 3): Cu, 89%; Ni, 82%; 42-alloy, 80%
Solder paste (Comp.Ex.): Cu, 79%; Ni, 73%; 42-alloy, 72%

By the way, when a solder paste was subjected to a spreadability test using a flux having the same composition as described above except that 3% of copper powder (10-50 μm in particle diameter) was substituted for 5% of aniline copper chloride complex, it was possible to obtain almost the same results as obtained in the spreadability test of this Example.

Further, when a solder paste was subjected to a spreadability test using a flux having the same composition as described above except that 1% of nickel dimethylglyoxime was not included, the spreadability in each sample metals was lowered by 3% as compared with that obtained in the spreadability test of the solder paste of this Example.

It will be clear from these results that it was possible, through the incorporation of the metal or the metal compound into the flux, to improve the wettability of solder to copper. Likewise, it was possible, through the incorporation of a nickel compound into the flux, to improve the wettability of solder to nickel and 42-alloy.

### EXAMPLE 4

One example of solder paste prepared using Sn—Zn-based solder powder.

Since a solder paste prepared using Sn—Zn-based solder powder is characterized in that the reaction between the zinc in this solder and components of flux is more active than that of the components of other lead-free solder, this Sn—Zn-based solder is inferior in terms of storage stability and soldering properties. Therefore, in this example, the Sn—Zn-based solder was coated with copper to overcome the aforementioned drawbacks.

Solder pastes of comparative example and example were prepared in the same manner as in Example 3 except that 6% of copper acetyl acetone was substituted for 5% of aniline copper chloride complex and 1% of nickel dimethylglyoxime, and solder powder (91.2Sn-8.8Zn; melting point=198.5° C.) (comparative example) and solder powder having copper coating (example) were respectively substituted for the solder powder (96.5Sn-3.0Ag-0.5Cu). By the way, on this occasion, a solder paste where 6% of copper acetyl acetone was omitted therefrom was also subjected to the spreadability test. By the way, although the coating with copper may be performed by means of plating method, the substitution reaction of organometal copper was utilized in this example (the solder powder was dipped in an ethyl alcohol solution of organic copper salt such as copper palmitate and heated with stirring to precipitate copper on the surface of solder powder, after which the solder powder was separated through filtration, washed and dried).

The solder paste thus obtained was stored for one month at room temperature (about 20° C.) and changes thereof was visually observed and subjected to the test according to JIS-Z-3197 to determine the spreadability (%) of solder, the results shown below.

| | | External appearance | | Spreadability | |
|---|---|---|---|---|---|
| | Cu acetyl | | After | | After |
| Cu coating | acetone | Initial | one month | Initial | one month |
| Yes | Yes | Good | Good | 86 | 86 |
| Yes | None | Good | Good | 86 | 85 |
| None | Yes | Good | Roughened | 86 | 85 |
| (Comp. Ex.) | | | | | |
| None | None | Good | Roughened | 78 | 78 |
| (Comp. Ex.) | | | | | |

It will be clear from these results that it was possible, through the incorporation of the metal compound into the flux, to improve the wettability of solder to copper. Likewise, it was possible, through the coating of solder powder with copper, to improve the storage stability of solder paste.

### EXAMPLE 5

One example where the present invention was applied to a flux for special metal will be explained.

30% of rosin, 10% of monoethanol amine, 10% of diehanol amine, 1% of diethanol amine hydrofluoric ester, 5% of diethanol amine hydroborofluoric ester were mixed together and allowed to react for 20 minutes at a temperature of 100° C. to obtain a mixture comprising partially aminated rosin (a half of rosin was not aminated) and unreacted amine, amine fluoride and borofluoride. To this mixture was added 3% of copper fluoride as a metal compound. Then, the resultant mixture was stirred, allowing a reaction to take place, for 30 minutes at a temperature of 100° C., thereby obtaining a flux for special metal.

While a flux comprising the same composition as described above except that the aforementioned copper fluoride is not included therein is capable of enabling an Sn—Pb-based solder or a lead-free solder to exhibit excellent wettability to iron, nickel or aluminum which are considered relatively difficult to solder, the flux is only capable of enabling a lead-free solder to exhibit a spreadability of about 80% when the matrix metal is constituted by copper. Whereas, the aforementioned flux for special metal was found capable of enhancing the wet-spreadability thereof up to about 90% even if the matrix metal was constituted by copper. In the case of this flux for special metal, it is no longer required to undergo troublesome process to incorporate hydrofluoric acid into a flux to precipitate a reaction product so as to utilize it as required in the conventional flux.

By the way, it is possible, as required, to incorporate known activating agents such as amine halogenate, organic halides, various kinds of chelated compounds, organic acids, etc.

Further, rosin, amine, fluoride, borofluoride mentioned above can be employed at the aforementioned mixing ratios.

Since the flux of this example is excellent in corrosion resistance and insulating properties, it can be employed for a lead-free solder or for a rosin-containing solder or dissolved in a solvent to enable it utilize as a paste-like flux or as a liquid flux.

### EXAMPLE 6

One example where the present invention was applied to a flux for hot air leveler will be explained.

10% of aniline hydrochloride, 10% of pure water, 65% of EO(10)adduct of bisphenol A (EO is ethylene oxide), 3% of copper chloride as a metal compound, and the balance of isopropyl alcohol (100% in total) were mixed together and stirred to obtain a water-soluble flux. By making use of this water-soluble flux, a lead-free solder (96.5Sn-3.0Ag-0.5Cu) was applied to a glass epoxy through-hole substrate by means of solder-leveling treatment. As a result, it was possible to exhibit excellent solder-wettability and to obtain uniform coated layer. Whereas, when a lead-free solder comprising the same composition except that the aforementioned metal compound was excluded was employed and applied to a glass epoxy through-hole substrate in the same manner as described above, it was impossible to uniformly form a coated layer, generating runaway of solder. By the way, when the flux of this example was employed, the spreadability was 90%, whereas in the case of the flux containing no metallic compound, the spreadability was 80%.

### EXAMPLE 7

One example where the present invention was applied to an inorganic strongly active flux will be explained.

35% of ZnCl₂ (zinc chloride), 15% of NH₄Cl (ammonium chloride), 5% of hydrochloric acid, 5% of copper chloride (metal compound), 2% of iron chloride (metal compound), and the balance of pure water (100% in total) were mixed together and stirred to obtain a flux.

This flux can be applied to the soldering using a high-temperature solder such as the soldering of a radiator (brass) or to the soldering of brass, copper oxide or low carbon steel. In the case of soldering of a radiator (brass), while it is possible to realize a spreadability of 90% through the employment of the conventional high-temperature solder, i.e. 40Sn-60Pb, it is possible, through the employment of the aforementioned flux, to realize a spreadability of 90% even when a lead-free solder such as 97.5Sn-2.5Ag (melting point=226° C.) or 97Sn-3Cu (melting point=300° C.) is employed. Since it is possible to realize a spreadability of only 80% when a solder not containing any of the aforementioned metal compounds is employed, it would be clear that it is possible, through the employment of the aforementioned flux, to enhance the wettability of solder.

### EXAMPLE 8

The effects of metallic compounds on the wettability of solder depending on various kinds of activating agents were investigated. In the case of the metal compounds containing no halogen, the wettability of solder was greatly influenced by the kinds of activating agent.

10% of rosin, 5% of polymerized rosin, 4% of copper dimethylglyoxime (metal compound), 0.6% of various kinds of activating agents and the balance of ethyl alcohol (100% in total) were mixed together and stirred to obtain a flux. By making use of this flux, solder spreadability test of a lead-free solder (96.5Sn-3.0Ag-0.5Cu) was performed in the same manner as in Example 1, the results being illustrated as follows.

(Kinds of Activating Agents)
Organic acid type: succinic acid
Halogenated organic acid: monochloroacetic acid, chlorendic anhydride
Amine organic acid: ethylamine palmitic acid
Amine halogenate: ethylamine hydrochloride, ethylamine hydrobromate, cyclohexylamine hydrochloride, aniline hydrochloride
Amine hydrofluoric acid: n-butylamine hydrofluoric acid
Amine hydroborofluoric acid: ethylamine hydroborofluoric acid, diphenyl guanidine hydroborofluoric acid
Halogenated organic compound: 2,3-dibromopropanol

(Results of Solder Spreadability Test)

The number in the parenthesis shown in the following table represents the result of solder spreadability test which was performed using a flux having the same composition as described above except that the aforementioned metal compound was not included therein.

The following table also shows the result of solder spreadability test which was performed in the same manner as described above except that a lead-containing solder formed of 63Sn-37Pb was substituted for the lead-free solder.

| | spreadability | spreadability |
|---|---|---|
| Kinds of activating agent | (%)(lead-free) | (%)(lead-included) |
| Base composition | 77(75) | 75(80) |
| Organic acid | 83(75) | 80(83) |
| Halogenated organic acid | 86(78) | 84(93) |
| Amine organic acid | 80(78) | 81(83) |
| Amine halogenate | 85(80) | 90(93) |
| Amine hydrofluoric acid | 85(80) | 90(93) |
| Amine hydroborofluoric acid | 88(80) | 90(93) |
| Halogenated organic compound | 85(80) | 90(93) |

By the way, “base composition” indicates the case where the same kind of flux except that the activating agent was not included was employed.

The following facts can be understood from the above results.

When a metal compound is incorporated into a flux and a lead-free solder is employed, the wettability of solder can be enhanced. But if a lead-containing solder is employed in this case, the wettability of solder would be deteriorated.

If the wettability of lead-free solder is to be enhanced, it would be especially effective to incorporate a metal compound into a flux and also additionally incorporate another activating agent. As for the activating agent to be employed in this case, most effective examples of which include amine halogenate, amine hydroborofluoric acid, halogenated organic acid and halogenated organic compound. Organic acids are more or less effective in accelerating the wetting of solder.

The aforementioned facts can be also applied to at least one kind of metal selected from copper-based metal and nickel-based metal, to inorganic salts of copper-based metal and nickel-based metal, to inorganic complexes of copper-based metal and nickel-based metal, and to organic complexes of copper-based metal and nickel-based metal (i.e. metal complexes of organic compounds where atoms of N, O and S in amine (excluding nitrogen-containing hetrocyclic compounds), imine (excluding nitrogen-containing hetrocyclic compounds), oxime, ketone, alkoxy and thioketone are coordinated with a metal). Further, The same may be also said of the metal compounds containing no halogen among the copper-based metal, nickel-based metal, inorganic salts of these metals, inorganic complexes of these metals, and organic complexes of, these metals. With respect to the preflux, the same results as described above were obtained when 3% of copper palmitate and 1% of copper acetate were substituted for 4% of dimethylglyoxime (metal compound). The same may be also said of the metal compounds containing no halogen among the copper-based metal, nickel-based metal, inorganic salts of these metals, inorganic complexes of these metals, and organic complexes of these metals. Namely, the same can be also applied to preflux.

### REFERENCE EXAMPLE 1

18% of rosin (mass %, the same hereinafter), 5% of polymerized rosin, 0.3% of 2,3-dibromosuccinic acid, 0.4% of ethylamine hydrochloride, 0.3% of diphenyl guanidine hydrobromate, 0.4% of palmitic acid, 0.4% of n-butylamine hydroborofluoric ester, and the balance of ethyl alcohol (100% in total) were mixed together to obtain a mixture, to which 2% of copper palmitate (as a copper compound), 2% of copper rosinate, 0.5% of copper acetate (0.6% as metal copper in the flux) was added and then mixed and stirred to obtain a rosin-based flux for printed wiring board.

Herein, by making use of rosin-based flux for printed wiring board while varying the content of copper (% as metal copper in the flux) through the change of the content of copper acetate, the soldering using a lead-free solder (96.5Sn-3.0Ag-0.5Cu) (melting point: 217° C.) was performed to measure the spreadability of the solder based on JIS-Z-3197, the results being illustrated by a solid line in the graph of FIG. 1.

By the way, the spreadability of the solder where the content of copper is optimum will be illustrated together with the spreadability obtained from the employment of other kinds of lead-free solders.

| | Mp. | Optimum Cu | |
|---|---|---|---|
| Lead-free solder | (° C.) | content | Spreadability |
| 96.5Sn-3.0Ag-0.5Cu | 217 | 0.1-3% | 89% |
| 99.3Sn-0.7Cu | 227 | 0.1-3% | 89% |
| 96.5Sn-3.5Ag | 221 | 0.1-3% | 88% |
| 91.2Sn-8.8Zn | 198.5 | 0.1-3% | 87% |
| 58Sn-42Bi | 139 | 0.05-2% | 90% |

### COMPARATIVE EXAMPLE 1

By making use of a flux having same composition as that of Example 1 except that the copper compound was not employed, the same test as that of Example 1 was performed in the same manner to measure the spreadability of solder, the results being shown below. By the way, for the purpose of comparison, the results obtained through the employment of lead-containing solder are also shown below.

| | Mp. | |
|---|---|---|
| Lead-free solder | (° C.) | Spreadability |
| 96.5Sn-3.0Ag-0.5Cu | 217 | 78% |
| 99.3Sn-0.7Cu | 227 | 78% |
| 96.5Sn-3.5Ag | 221 | 76% |
| 91.2Sn-8.8Zn | 198.5 | 75% |
| 58Sn-42Bi | 139 | 85% |
| 63Sn-37Pb (Comp. Ex.) | 183 | 93% |

### REFERENCE EXAMPLE 2

This example describes about a solder paste using an organic ester.

55% of rosin, 6% of hydrogenated caster oil (thixotropic agent), 1% of diphenyl guanidine (activating agent), 0.5% of 2,3-dibrome succinic acid, 0.3% of dimethyl amine hydrochloride, 5% of copper palmitate, 1% of nickel stearate, and the balance of carbitol (solvent) (100% in total) were mixed and stirred to obtain a mixture.

10% of this flux and 90% of lead/zinc-free solder powder (96.5Sn-3.0Ag-0.5Cu)(10-50 μm in particle diameter) were kneaded together to obtain a solder paste. Since this solder paste contained organic copper salt and organic nickel salt, changes in viscosity with time was found more prominent in this solder paste as compared with the solder paste of Example 3, thus indicating that this solder paste was inferior in storage stability and solder wettability on the occasion of soldering as compared with the solder paste of Example 3.

When this solder paste was subjected to a spreadability test in the same manner as in Example 1, this solder paste was found more excellent in wettability and bonding strength as compared with those of a solder paste (comparative example) which was obtained from the same composition as described above except that the metal compounds (5% of copper palmitate and 1% of nickel stearate) were not included. Namely, when the solder paste of this example and the solder paste of the comparative example were subjected to solder spreadability test using copper, nickel and 43-alloy as a matrix metal, the following results were obtained.
Solder paste (Ex. 3): Cu, 89%; Ni, 82%; 42-alloy, 80%
Solder paste (Comp.Ex.): Cu, 79%; Ni, 73%; 42-alloy, 72%

It will be clear from these results that it was possible, through the incorporation of organic copper salt and organic nickel salt into the flux, to improve the wettability of solder to copper. Likewise, it was possible, through the incorporation of a nickel compound in to the flux, to improve the wettability of solder to nickel and 42-alloy.

In the inventions set forth in the aforementioned items (1) to (7), “soldering” includes the soldering where a precipitation type solder composition was employed. The present invention is of course applicable to the soldering to be performed on a substrate which is constituted by at least one of copper-based metal and nickel-based metal.

1. A preflux which is designed to be used in soldering using a lead-free solder containing tin as a major component and not containing lead, wherein the preflux contains at least one kind of material selected from the group consisting of an inorganic salt of copper-based metal and/or a nickel-based metal, an inorganic complex of copper-based metal and/or a nickel-based metal, an organic complex of copper-based metal and/or a nickel-based metal, and an organic ester of copper-based metal and/or a nickel-based metal.

2. A flux which is designed to be used in a soldering using a lead-free and zinc-free solder containing tin as a major component and not containing lead, the soldering being adapted to be applied to a surface portion which is constituted by a copper-based metal and/or a nickel-based metal (excluding the case where the surface portion is constituted by electroless nickel plating), wherein the flux contains at least one kind of material selected from the group consisting of a copper-based metal, a nickel-based metal, an inorganic salt of copper-based metal and/or a nickel-based metal, an inorganic complex of copper-based metal and/or a nickel-based metal, and an organic complex of copper-based metal and/or a nickel-based metal (a metal complex of an organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal).

3. The flux according to claim 2, wherein the flux is designed to be employed in a soldering using a lead-free solder containing tin as a major component, containing zinc and not containing lead, the soldering being adapted to be applied to a surface portion which is constituted by a copper-based metal and/or a nickel-based metal (excluding the case where the surface portion is constituted by electroless nickel plating), wherein the flux contains 0.01 to 8% (as reduced to metal) of at least one kind of material selected from the group consisting of a copper-based metal, a nickel-based metal, an inorganic salt of copper-based metal and/or a nickel-based metal, an inorganic complex of copper-based metal and/or a nickel-based metal, and an organic complex of copper-based metal and/or a nickel-based metal (a metal complex of an organic compound where atoms of N, O and S in amine (excluding nitrogen-containing hetrocyclic compounds), imine (excluding nitrogen-containing hetrocyclic compounds), oxime, ketone, alkoxy and thioketone are coordinated with a metal).

4. The flux according to claim 2, which contains at least one kind of material selected from the group consisting of an organic acid, amine, an organic amine salt, amine halogenate, amine hydroborofluoride, amine trifluoride/boron complex salt, and organic halides.

5. The flux according to claim 3, which contains at least one kind of material selected from the group consisting of an organic acid, amine, an organic amine salt, amine halogenate, amine hydroborofluoride, amine trifluoride/boron complex salt, and organic halides.

6. The flux according to claim 2, which further contains a resin component.

7. The flux according to claim 3, which further contains a resin component.

8. The preflux or flux according to claim 1, which is adapted to be employed in a printed wiring board.

9. The preflux or flux according to claim 2, which is adapted to be employed in a printed wiring board.

10. The preflux or flux according to claim 3, which is adapted to be employed in a printed wiring board.

11. A solder paste to be obtained using the flux of claim 2.

12. A solder paste to be obtained using the flux of claim 3.

13. A solder paste to be obtained using the flux of claim 4.

14. A solder paste to be obtained using the flux of claim 5.

15. A solder paste to be obtained using the flux of claim 6.

16. The solder paste according to claim 2, wherein the solder paste to be obtained by making use of a flux containing a copper-based metal and/or a nickel-based metal is obtained by making use of coated solder powder which can be obtained by coating lead-free solder powder containing tin as a major component and not containing lead with a copper-based metal and/or a nickel-based metal.

17. The solder paste according to claim 3, wherein the solder paste to be obtained by making use of a flux containing a copper-based metal and/or a nickel-based metal is obtained by making use of coated solder powder which can be obtained by coating lead-free solder powder containing tin as a major component and not containing lead with a copper-based metal and/or a nickel-based metal.

18. A method of manufacturing a soldered body by making use of a lead-free or lead-free/zinc-free solder wherein the preflux as set forth in claim 1, the method being featured in that, by making use of heat at the time of soldering or by making use of an activating agent (if the activating agent is employed), the metal and/or the metal compound are activated to enable the activated substance to exist on the surface of the metal or at the soldering portion, thereby enabling an intermetallic compound to generate at the soldering portion to enhance the wettability of fused solder and/or to prevent the deterioration of bonding strength of solder due to an excessive growth of the intermetallic compound.

19. A method of manufacturing a soldered body by making use of a lead-free or lead-free/zinc-free solder wherein the flux as set forth in claim 2, the method being featured in that, by making use of heat at the time of soldering or by making use of an activating agent (if the activating agent is employed), the metal and/or the metal compound are activated to enable the activated substance to exist on the surface of the metal or at the soldering portion, thereby enabling an intermetallic compound to generate at the soldering portion to enhance the wettability of fused solder and/or to prevent the deterioration of bonding strength of solder due to an excessive growth of the intermetallic compound.

20. A method of manufacturing a soldered body by making use of a lead-free or lead-free/zinc-free solder wherein the flux as set forth in claim 3, the method being featured in that, by making use of heat at the time of soldering or by making use of an activating agent (if the activating agent is employed), the metal and/or the metal compound are activated to enable the activated substance to exist on the surface of the metal or at the soldering portion, thereby enabling an intermetallic compound to generate at the soldering portion to enhance the wettability of fused solder and/or to prevent the deterioration of bonding strength of solder due to an excessive growth of the intermetallic compound.
